(19) United States
(12) Patent Application Publication
(10) Pub. No.: US 2014/0006153 A1
(43) Pub. Date: Jan. 2, 2014

(54) SYSTEM FOR MAKING PERSONALIZED OFFERS FOR BUSINESS FACILITATION OF AN ENTITY AND METHODS THEREOF

(71) Applicant: Infosys Limited, Bangalore (IN)

(72) Inventors: Sivaram Vargheese Thangam, Kanyakumari District (IN); Sunil Arora, Haibowal Kalan (IN); Prasanna Nagesh Teli, Ramanmala (IN); Radha Krishna Pisipati, Masabtank (IN); Swaminathan Natarajan, Bangalore (IN); Venugopal Subbarao, Bangalore (IN)

(21) Appl. No.: 13/929,768

(22) Filed: Jun. 27, 2013

(30) Foreign Application Priority Data
Jun. 27, 2012 (IN) 2548/CHE/2012

(51) Int. Cl. G06Q 50/00; G06Q 30/02

(52) U.S. Cl. CPC G06Q 50/01; G06Q 30/0255
USPC 705/14.53; 705/14.66

(57) ABSTRACT

Systems and methods for leveraging social data by entities to acquire new customers through social channels are disclosed. Offers are personalized as these are transmitted based on the desire of the prospect, which may be expressed through network activities. The interest profile of members of social network communities is determined and offers are propagated through conduits having a high influence score. Implementation of these engines is disclosed. If there are multiple people connected to a conduit, the prospect whose degree of social interaction is high may be considered for making the offer available to the prospect.

### RELATED APPLICATION DATA

This application claims priority to India Patent Application No. 2548/CHE/2012, filed Jun. 27, 2013, the disclosure of which is hereby incorporated by reference in its entirety.

### FIELD OF THE INVENTION

The present disclosure relates in general to the field of computer networks, and more particularly, to a system and method that utilize social networks for determining a conduit and prospect pair for the purposes of transmitting personalized offers.

### BACKGROUND OF THE INVENTION

Online social networks (hereinafter may be referred to as ‘OSN’) are popular platforms for interaction, communication and collaboration between friends. The term ‘online social network’, as used herein, means web-based services that allow users to construct a public or a semi-public profile within the boundary of that particular community. In addition, it provides a facility to consolidate a list of other users with whom they share or may want to share a connection. OSNs comprise a large number of users who are potential content generators with massive source of information. Users are encouraged to share a variety of personal identity related information, including, but not limited to, social and cultural attributes. When one of the users provides access to his or her social network, s/he provides an opportunity to connect and influence his or her circle of friends on the OSN. The nature and nomenclature of these connections may vary from website to website and for the purposes of this disclosure, each online social networking website is referred to as ‘Social Network Community’. The insights derived from the social data and the connections of the user can be leveraged to generate business from the circle of users on these communities by displaying one or more offers which may be applicable to them. The term ‘offer’, as used herein, means the act of putting forward a proposal for a marketable commodity consisting of goods, services or both.

There exist several methodologies for the same. An offer may be generated by an entity which may be shared by one user A to another user B through an online mechanism. These offers may have incentivizing schemes attached to it where the user A is rewarded once user B connects with the entity. The offer generated is generic as it is targeted for a large population. In addition, user A may be asked to refer the offer to any of his or her circle of friends which s/he deems fit. In another instance, user A can generate a coupon from the mechanism provided by the entity and share the coupon with his or her circle of friends or public population through any offline or online means which may include, for example, blogs, forums, emails, or social network. When an online user B uses the coupon to get a discount on doing a transaction, user A may be rewarded. In yet another instance, static widgets may be placed in entity portals where users can utilize them to share the offer to his friends. In the above instances, user A may not have good knowledge about the entity and therefore s/he may not be in a position to explain or talk about the offerings. All these limitations would entertain mass spreading of unsolicited offers which may end up in bringing bad reputation to the entity by spamming of offers. The offers are broadcasted without determining whether there is a desire or interest for such an offer. There exists a need to provide personalized offers to these users.

The disclosure proposes an improved method and a system for generating and forwarding personalized offers on social channels by determining a prospect and a conduit pair. It utilizes the notion of social networks communities being a data pool to facilitate business.

### SUMMARY OF THE INVENTION

Aspects of the disclosure relate to a system and method for generating personalized offers for business facilitation of an entity.

It is therefore one object of the present disclosure to provide systems and methods for generating personalized offers based on online social network activities. Offers are generated utilizing the interest profile of the prospect.

It is another object of the present disclosure to determine a prospect and a conduit pair for generating and utilizing one or more offers. Social influence of a conduit is calculated to determine the conduit for transmitting the offer.

It is yet another object of the present disclosure to have an incentivizing program in place for rewarding a conduit for every successful conversion of a prospect to a lead.

The above as well as additional aspects and advantages of the disclosure will become apparent in the following detailed written description

### BRIEF DESCRIPTION OF THE DRAWINGS

The aspects of the disclosure will be better understood with the accompanying drawings.

FIG. 1 (PRIOR ART) is a block diagram of a computing device to which the present disclosure may be applied.

FIG. 2 shows a schematic block diagram to illustrate system for generating personalized offers for business facilitation of an entity in accordance with the present disclosure.

FIG. 3 shows a schematic block diagram to illustrate a method for generating personalized offers for business facilitation of an entity in accordance with the present disclosure.

While systems and methods are described herein by way of example and embodiments, those skilled in the art recognize that systems and methods disclosed herein are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-readable media for leveraging social data by entities to acquire new customers through social channels. The embodiments described herein are related to generation of personalized offers. While the particular embodiments described herein may illustrate the invention in a particular domain, the broad principles behind these embodiments could be applied in other fields of endeavor. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure.

It is also to be understood that the present disclosure may be implemented in various forms of hardware, software, firmware, special purpose processors, or a combination thereof Preferably, the present invention is implemented in software as a program tangibly embodied on a program storage device. The program may be uploaded to, and executed by, a machine comprising any suitable architecture.

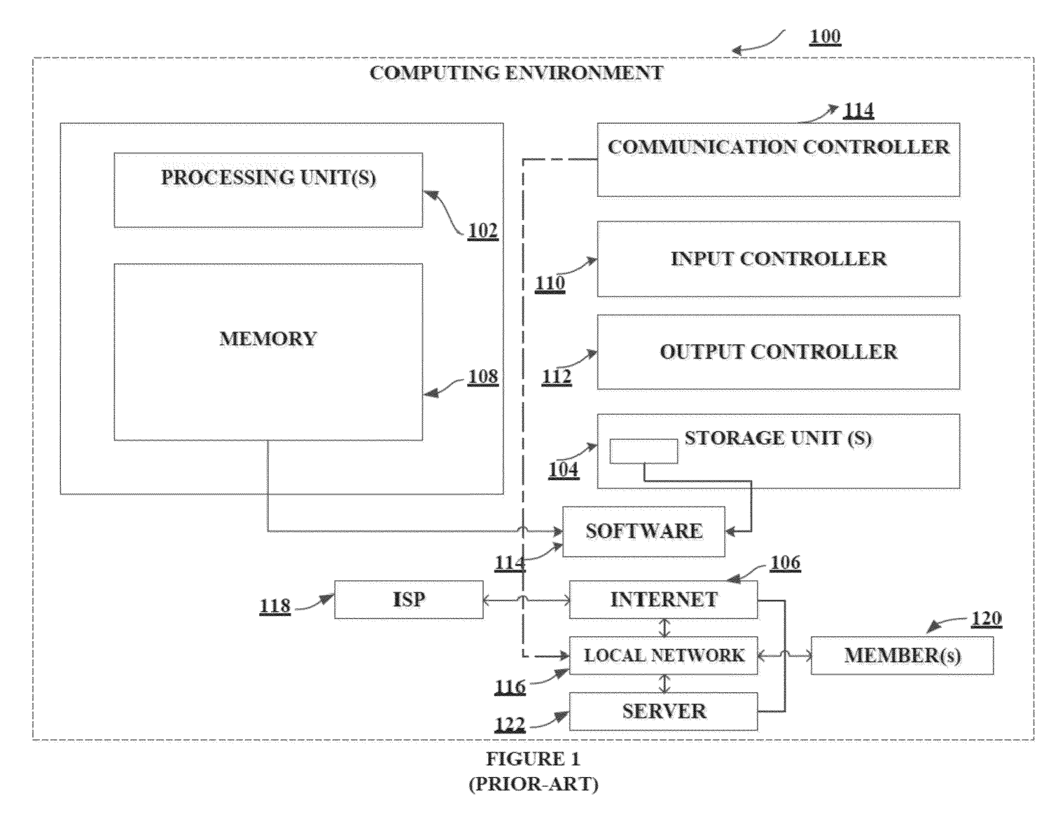

FIG. 1 (PRIOR-ART) is a block diagram of a computing device 100 to which the present disclosure may be applied according to an embodiment of the present disclosure. The system includes at least one processor 102, designed to process instructions, for example computer readable instructions (i.e., code) stored on a storage device 104. By processing instructions, processing device 102 may perform the steps and functions disclosed herein. Storage device 104 may be any type of storage device, for example, but not limited to an optical storage device, a magnetic storage device, a solid state storage device and a non-transitory storage device. Alternatively, instructions may be stored in one or more remote storage devices, for example storage devices accessed over a network or the internet 106. The computing device also includes an operating system and microinstruction code. The various processes and functions described herein may either be part of the microinstruction code or part of the program (or combination thereof) which is executed via the operating system. Computing device 100 additionally may have memory 108, an input controller 110, and an output controller 112 and communication controller 114. A bus (not shown) may operatively couple components of computing device 100, including processor 102, memory 108, storage device 104, input controller 110 output controller 112, and any other devices (e.g., network controllers, sound controllers, etc.). Output controller 110 may be operatively coupled (e.g., via a wired or wireless connection) to a display device (e.g., a monitor, television, mobile device screen, touch-display, etc.) in such a fashion that output controller 110 can transform the display on display device (e.g., in response to modules executed). Input controller 108 may be operatively coupled (e.g., via a wired or wireless connection) to input device (e.g., mouse, keyboard, touch-pad, scroll-ball, touch-display, etc.) in such a fashion that input can be received from a user. The communication controller 114 is coupled to a bus (not shown) and provides a two-way coupling through a network link to the internet 106 that is connected to a local network 116 and operated by an internet service provider (hereinafter referred to as ‘ISP’) 118 which provides data communication services to the internet. Members 120 may be connected to the local network 116. Network link typically provides data communication through one or more networks to other data devices. For example, network link may provide a connection through local network 116 to a host computer, to data equipment operated by an ISP 118. A server 122 may transmit a requested code for an application through internet 106, ISP 118, local network 116 and communication controller 114. Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be one or more servers, for example a farm of networked servers, a clustered server environment, or a cloud network of computing devices.

Existing members of online social networks are utilized as conduits to reach one or more prospects. As used herein, the term ‘conduit’ refers to a person who acts as a channel for conveying personalized offers to prospects. As used herein, the term ‘prospect’ means members of the social network community who are communicated for personalized offers, on behalf of conduits. Offers are personalized as these are transmitted based on the desire of the prospect, which may be expressed through network activities. If there are multiple people connected to a conduit, the prospect whose degree of social interaction is high may be considered for making the offer available to the prospect. Alternatively, if a prospect is connected to multiple conduits, the conduit with a high degree of social interaction may be considered for making the offer available to the prospect. On successful acceptance of offer, incentivizing mechanism may be rolled out for conduits, based on their social influence.

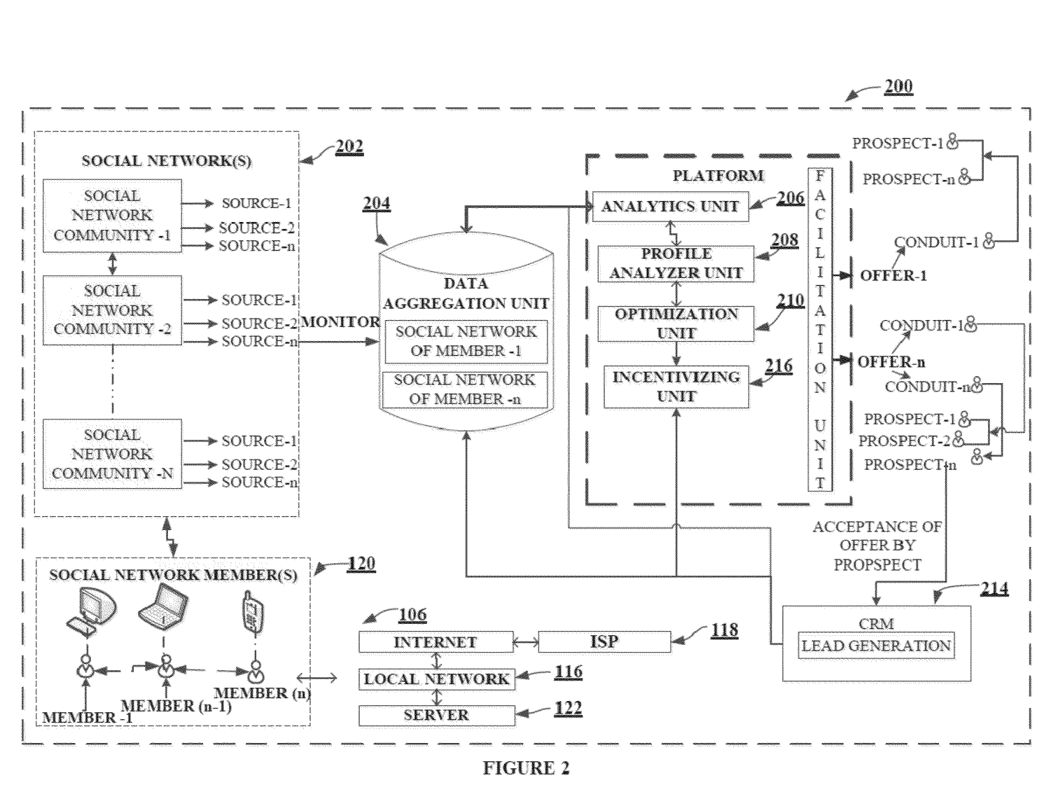

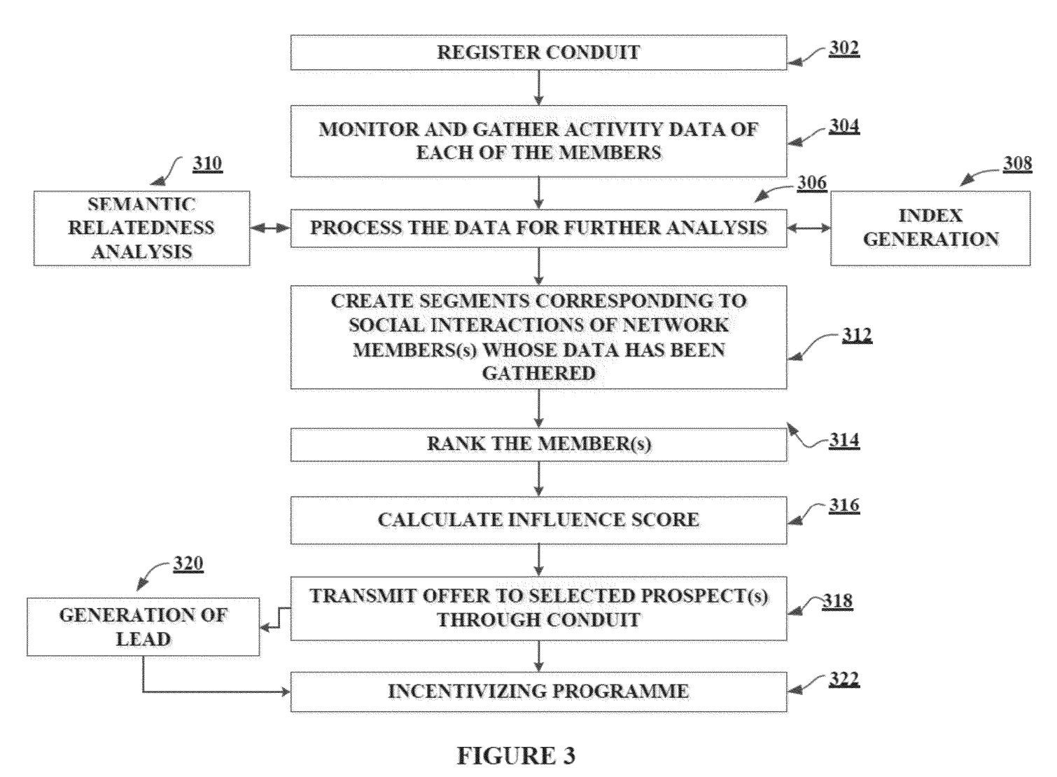

FIG. 2 in conjunction with FIG. 3 illustrates a system 200 and a method 300 respectively, for applying the embodiments of the present disclosure. Social network community is perceived as a social structure, defined by with a set of member(s) 120 and a set of relationships connecting these members. Member(s) 120 may include, but not limited to, different entities, organizations, persons, nations. Members 120 may be connected to the local network 116. Network link may provide a connection through local network 116 to a host computer, to data equipment operated by an ISP 118. A server 122 may transmit a requested code for an application through internet 106, ISP 118, local network 116 and communication controller 114. Members 120 may belong to one or more social network communities 202. Each of the social network communities are data pools from various sources which include, for example, third party applications, groups and posts. According to an embodiment of the present disclosure, an entity may launch an application for promotion of its goods or services. The application can be a service portal inviting people to register 302 for promotion of campaigns in return of rewards for successful conversions. An entity includes, but is not limited to, a web entity, a partnership, a disparate group, a business, group of individuals and an individual. The application may be accessible through the web-site of the entity. Alternatively, the application may be accessible as a third party application through social network communities 202. Alternatively, an entity may choose to send out invites to a limited number of people, based on their credentials, for promotion of their campaign through social channels. A campaign may comprise of a single or multiple offers. Credentials may include, for example, social and transactional credibility. The application may ask the person to login with details, in particular, pointing to various social network communities 202 with which s/he is registered, in order to evaluate the eligibility to be a part of the campaign. An authorization may be required by the person to access his or her social networks activities. The system 200 accesses and analyzes the person's social network communities 202 for his social information along with the social information of his friend connections. The kind of information that can be used to make an inference in the social context includes, but not limited to, social footprint i.e. the group of friends, communication patters through wall messages, pictures, videos, times and duration of activity for example, when user connected to the network, specific activity of interest which took place, the application which a member may be utilizing. If the person becomes eligible, then the registration process is completed 302. As part of the registration process, the system 200 may narrow down to a subset of social network communities to which the conduit is registered by identifying the most profitable or most responsive social network communities to promote their campaign. If s/he becomes eligible, system behind the social application starts listening to the social network communities of the conduit 304, which have been shortlisted. Network activities include, but not limited to, conversations, likes, interests or buzz. These activities are fetched and analyzed semantically. The kind of information that can be used to make an inference in the social context includes, but not limited to, social footprint i.e. the group of friends, communication patters through wall messages, pictures, videos, times and duration of activity for example, when user connected to the network, specific activity of interest which took place, the application which a member may be utilizing. Many social network communities also enable members to create special interest groups. Users can post messages to groups and even upload shared content to the group. All of the content uploaded by a given user is listed in the user's profile, allowing other users to browse through the social network to discover new content. If the person becomes eligible, then the registration process is completed 302. As part of the registration process, the system 200 may narrow down to a subset of social network communities to which the conduit is registered by identifying the most profitable or most responsive social network communities to promote their campaign. The data aggregation unit 204 monitors and gathers the social network community's activity for each of the members 304. For example, a member of a social network community may have a wall post discussion regarding a mutual fund product. This activity may be gathered by the data aggregation unit against a configured set of goods or services.

Next, the analytics unit 206 performs a semantic analysis 306 on the gathered data using index generation 308 or semantic relatedness analysis 310 technique. Preferably, the index generation 308 is applied. Index terms or phrases are n-gram terms that cover all the important terms which are not necessarily the key-phrases. Index generation is a closely related field to key-phrase extraction with the difference being the length. The number of index terms is typically more than the number of key-phrases and the set of key-phrases is generally a sub-set of the set of index-terms for particular source content. The first step consists of fetching the data from the source system and converting the source content into plain text format. This text contains sequences of sentences. The second step consists of identifying candidate phrases using linguistic as well as statistical approach. Candidate phrases from both the approaches are combined to generate a single list of candidate phrases. Candidate phrases constitute the initial list of phrases that have a good probability of being included in the list of final index phrases. The process consists of creating an initial list of candidate phrases and assigning numerical scores to each of the phrases, thereafter the phrases are ranked and only the top ‘N’ are selected as output of the system. Two approaches may be used for initial candidate phrase generation, namely, linguistic approach and statistical approach. Linguistic approach exploits the knowledge of language for intelligent text processing. Sentence splitting, part of speech tagging and noun phrase chunking is done for the purpose of generating candidate phrases. The plain text needs to be split into different sentences for further processing. The next step after sentence splitting is part of speech tagging. Known methods such Stanford Log-linear Part-Of-Speech (hereinafter may be referred to as ‘POS’) Tagger may be used for tagging the sentences with Parts Of Speech. The POS Tagger gives tagged output string. The initial list of candidate phrases is obtained by matching the pattern on the result obtained by applying part-of-speech tagging to the input text. Statistical approach to candidate phrase generation relies on the probability of co-occurrence of words in the text. Pairs of words are grouped as phrases, which mostly occur together when compared to their number of occurrences separately as individual words. If the number of words in a source content is N, the total number of uni-grams (single word) and bi-grams (two consecutive word pair treated as a single lexical unit) will be equal to N and N-1 respectively. The frequency of each unique uni-gram and bi-gram is computed and then compute the probability or likelihood of a bi-gram being a phrase according to the following formula:

S(fw1:fw2)=fw1w2*{1/fw1+1/fw2}

where,

S(fw1: fw2)=A numerical score denoting the likelihood that the bi-gram is a phrase;

fw1w2=Frequency of the bi-gram w1w2 in the source content;

fw1=Frequency of word w1 in the source content;

fw2=Frequency of word w2 in the source content.

The third step primarily consists of applying various heuristics like frequency of a candidate phrase in the source content, distance of first occurrence from the beginning of source content and making use of phrase capitalizations information. Noun phrases, obtained using Linguistic approach and statistical approach are combined together by finding the union of the two. Also any noun phrase which has been extracted by both the approaches is counted only once. These combined noun phrases are called as candidate index terms or phrases:

C=L[S=n(L)+n(S)in(L|S)(2)]

where,

C=Combined Candidate Phrases

L=Set of noun phrases extracted using Linguistic Approach

S=set of noun phrases extracted using Statistical Approach

n=number of terms of the given type.

This step also consists of few data cleaning operations like eliminating punctuations from the end of candidate phrases or eliminating phrases that contains certain pre-defined characters and string. Application of domain-specific exclude-list is also done as part of this process. The domain specific exclude-list called as lexicon consists of single words or multi-word lexemes. The exclude list can be general-purpose or domain specific. The fourth and the final step consist of computing a single numerical score for each candidate phrase as a function of the scores multiplied by weights assigned to each heuristics for example, frequency, distance and capitalization. Frequency feature computes occurrence of a noun phrase in the given source content. The more frequent is the term the better is the chance of it qualifying it as index term. Frequency is normalized on the scale of 0 to 1. Also while computing frequency terms are compared insensitive to case, for example, if a source content contains word ‘Data Mining’ and ‘data mining’, then frequency of Data Mining is 2. For normalization of frequency following formula is used:

F(tᵢ)=(f−fₗ)/(fₕ−fₗ)

where,

F(ti)=Normalized Frequency

f=frequency of occurrence

f=minimum frequency

fₕ=maximum frequency

If fₗ=fₕ, then F(tᵢ)=0.

In source content, if a term is very important in the context of the source content, then it is very probable that it will appear in the beginning part of the source content. Thus distance of a noun phrase term from the beginning of the source content gives an idea about importance of the term. The distance is normalized and following formula is used:

D(tᵢ)=1−{dₜᵢ/1}

Where:

D(tᵢ)=Normalized Distance

Dₜᵢ=distance of the term ti from the beginning of the source content measured in no. of characters

l=length of the source content.

To compute capitalization information, terms occurring in title case are usually relatively more important than terms occurring in small case. Hence terms in title can be assigned higher weight, for example, the consider sentence “The process of data mining applies techniques like neural networks, decision trees or standard statistical techniques” and “Data Mining Hold for AMI Data?” Here ‘Data Mining’ in the second sentence carries more weightage than in the first sentence. The final output is essentially a list of key-phrases sorted according the numerical score such that the end user can select the ‘Top N’ score from the list. The final step also consists of generating the page number of each of the index phrase. All the candidate index terms are assigned a confidence factor. Confidence is computed as a weighted sum of the features. Values for weights can be prefixed and following formula is used:

C(tᵢ)=w₁*1(tᵢ)+w₂*Cap(tᵢ)+w₃*D(tᵢ)+w₄*F(tᵢ)

where,

C(tᵢ)=Confidence factor for term

I(tᵢ)=Intersection of term

Cap(tᵢ)=Capitalization Information for term

D(tᵢ)=Distance of term from the beginning of the source content

F(tᵢ)=Frequency of term in the source content

w₁;w₂;w₃;w₄=corresponding feature weights such that w₁+w₂+w₃+w₄=1

The second approach, semantic relatedness 310 technique is based on noun-phrase extraction, word-sense disambiguation, usage of the popular WordNet English lexical database and usage of algorithms for computing semantic relatedness between two words using Wordnet. There are two inputs to system, namely, gathered activity data of members and a list of classes each represented by a list of keywords. The list of key-words belonging to a single class can be regarded as a bag-of-words (hereinafter referred to as ‘BOW’). The first step consists of extracting all nouns from the gathered activity data as BOW. The raw textual data is first passed through a part-of-speech tagger for extracting singular and plural nouns. Preferably, the Stanford log-linear part-of-speech tagger is used. All the occurrences of a particular noun in a sentence and each occurrence is retained for further processing in the text processing pipeline. This is because, the frequency of the occurrence of a word is also important in computing the similarity score. The second step consists of finding the intended sense for each of the key-words describing a class and each noun extracted from the patent abstracts. The extracted nouns can have different meanings when used in different contexts and hence Word Sense Disambiguation) (hereinafter referred to as ‘WSD’) is performed to identify the intended meaning of a given target word based on the context of the surrounding or neighboring words. For WSD, “WordToSet” Perl package is preferably used. Two input parameters are passed to this package: a target word to which the sense needs to be assigned and a list of context words to be used for the purpose of disambiguating the target word. The target word is assigned the sense which is found to be the most related to its neighboring words or the context. The next step consists of computing the semantic relatedness between all the gathered activity data and all the pre-defined classes by computing the semantic relatedness between each word in the bag-of-words representing the gathered data with each word in the bag-of-words representing the classes, computing the semantic relatedness between a set of gathered data and one class using results from previous step and assigning the most probable class to the set of gathered data. Computing semantic related between text source content and class is an aggregation of semantic relatedness scores between all word pairs and normalization of these. The next task after computing individual scores between each set of gathered data and class is to output the top N classes (top N guesses) for each set and also output a confidence factor denoting how confident the system is in making its prediction. Confidence factor for a particular class is the percentage difference in normalized score between that particular class and class having score just below it.

Based on the semantic analysis of the activity 306 towards a configured set of good or services as part of the campaigns being floated, the profile analyzer unit 208 classifies the member into a segment 312 for the financial product and service. Segmentation may be preferably done by employing clustering techniques. Clustering is a division of data into groups of similar objects so as to partition the data into homogeneous groups such that objects in the same segment are more similar to each other than objects in different segments according to campaign offers. Preferably, the data clustering methods can be hierarchical, top-down approach or divisive. Divisive or cascaded algorithms begin with a whole set and proceed to divide it into smaller clusters. At first level, k-means clustering method is applied on demographic and personal data of members to group them according to their characteristics. K-means algorithm to categorical segments and segments with mixed numeric and categorical values. The k-modes algorithm uses a simple matching dissimilarity measure to deal with categorical objects, replaces the means of segments with modes, and uses a frequency-based method to update modes in the clustering process to minimize the clustering cost function. With these extensions the k-modes algorithm enables the clustering of categorical data in a fashion similar to k-means. Since some implementations of K-means only allow numerical values for attributes, it may be necessary to convert the data set into the standard spreadsheet format and convert categorical attributes to binary. Traditional data mining techniques is applied for fixing values for the segments. In the second level, fuzzy clustering method is employed on the specific segments generated from the first level. Each segment is considered at one time and clustering is applied on all data of members from specific clusters. The second level clustering helps to categorize the members into sub-groups based on their social interactions and topics they exchange.

The members are then ranked 314 by the optimization unit 210 in order to maximize the return of investment in context of the offer that may be forwarded to one or members identified as prospects. This optimization takes into account the interest profile of the member(s). The interest profile of each of the plurality of members is calculated by relating one or more transactional attributes of the offer with the social network community activities of each of the plurality of members. These activities are fetched and analyzed semantically along with the interest profile of participants of the network to determine the affinity towards configured set of products. If the sequence of activities of network participants shows strong affinity towards a product, the facilitation unit 212 identifies the member as a prospect for the given product.

The facilitation unit calculates 212 calculates a social influence value 316 for the conduits having the selected prospects in their circle of friends. As used herein, the term ‘social influence’ means the power of the conduit to influence the prospect(s) by their actions and reactions. Social influence is calculated by the following formula:

Social influence=(S+log F)/(N+log F)

Where,

S—Number of successful conversions

N—Total number of offers propogated

F—Social capital

The term ‘social capital’, as used herein, means the social credential of the conduit in the social network community to which the prospect belongs. It is typically calculated by taking weighed average of frequency of activity and volume of posts, comments, likes on posts from members, propagation of posts across social network communities, seriousness of the conduit on his identity, reference of conduit in other's posts and circle of friends. The value of social influence ranges from 0-1. The higher the value, greater is the social influence.

Personalized offers are generated by the facilitation unit 212 and reported to conduits whose social network community is common. Offers are generated only on desire or want of the prospect which is determined through the prospect's network activities and profile information. Generated offer is presented to the prospects by the conduit 318. If multiple conduits are connected to the same member, the conduit who has high social degree of relationship may be considered as the conduit for the chosen prospect. Prospect may be notified about the offer through social network system. Alternatively, offer may be sent through other routes, for example, emails. A prospect who receives a query can decide to accept or reject the offer. If not, the prospect may respond with a refusal to accept. Option may be available to generate a manual offer by routing the opportunity information to the customer relationship management (hereinafter referred to as ‘CRM’) system 214 and receives the offer back from it. Once the offer is accepted by the prospect, system 200 captures this information and pushes it as a lead into the CRM system 214. On successful conversion of an offer 320, the incentivizing unit 216, 322 notifies the conduit and determines a reward for the conduit, on the social influence and past conversions of offers. The conduit may redeem the reward through the system 200.

Having described and illustrated the principles of the disclosure with reference to described embodiments and accompanying drawings, it will be recognized by a person skilled in the art that the described embodiments may be modified in arrangement without departing from the principles described herein.

What is claimed is:

1. A computer-implemented method for determining a prospect and a conduit pair, for one or more offers on an online social network, the method comprising:
selecting, using a selection module, at least one social network community associated with the conduit registered for a campaign of an entity with the one or more offers for business facilitation of the entity;
ranking, using a ranking module, each of the plurality of members of the at least one social network community, wherein the ranking is based on content preference information of the one or more offers;
calculating, using a calculation module, an influence score of the conduit on the shortlisted members; wherein the members are shortlisted based on their ranking; and
identifying, using an identification module, the prospect and the conduit pair, wherein the one or more members with a high influence score are identified as the prospects.

2. The computer-implemented method in accordance with claim 1, wherein the plurality of members associated with the conduit are identified by generating a plurality of segments, wherein each segment corresponds to least one of the plurality of members based on social interactions of each of the plurality of members, wherein the segments are generated by applying data mining approaches on the gathered data.

3. The computer-implemented method in accordance with claim 1, wherein the ranking of each of the plurality of members comprises calculation of an interest profile score of each of the plurality of members to determine an affinity towards a marketable commodity selected from a group consisting of goods and services.

4. The computer-implemented method in accordance with claim 3, wherein the interest profile of each of the plurality of members is calculated by relating one or more transactional attributes of the offer with the social network community activities of each of the plurality of members.

5. The computer-implemented method in accordance with claim 1, wherein the entity comprises at least one of a web entity or a partnership or a disparate group or a business and a group of individuals or an individual or combinations thereof.

6. The computer-implemented method in accordance with claim 1, further comprising:
determining, using a determination module, if an offer for consideration, transmitted to one or more prospects, has been accepted;
identifying, using the identifying module, the one or more prospects as leads wherein the offer has been accepted; and
notifying, using a notifying module, the conduit with an electronic message regarding acceptance of the offer, wherein the conduit has been previously selected as a conduit for transmitting the offer to the lead.

7. A computer-implemented method of generating an offer, the method comprising:
selecting, using a selection module, at least one social network community associated with the conduit registered for a campaign of an entity with the one or more offers for business facilitation of the entity;
gathering, using a gathering module, activity data of each of the plurality of members of the at least one social network community;
segmenting, using a segmentation module, the plurality of members associated with the conduit, wherein each segment corresponds to least one of the plurality of members based on social interactions of each of the plurality of members, wherein the segments are generated by applying data mining approaches on the gathered data;
calculating, using a calculation module, an interest profile score of each of the plurality of members to determine an affinity towards a marketable commodity selected from a group consisting of goods and services;
calculating, using the calculation module, an influence score of the conduit on the shortlisted member; wherein the members are shortlisted based on their interest profiles;
identifying, using an identification module, the prospect and the conduit pair, wherein the one or more members with a high influence score are identified as the prospects;
transmitting the offer for consideration, to each of the one or more prospects, wherein the offer is an electronic message containing an offer to avail services or buy goods provided by an entity;
notifying, using a notification module, the conduit with an electronic message regarding acceptance of the offer, wherein the conduit has been previously selected as a conduit for transmitting the offer to the lead.

8. The computer-implemented method in accordance with claim 7, wherein the entity comprises at least one of a web entity or a partnership or a disparate group or a business and a group of individuals or an individual or combinations thereof.

9. The computer-implemented method in accordance with claim 7, wherein the interest profile of each of the plurality of members is computed by relating one or more transactional attributes of the offer with the social network activity of each of the plurality of members.

10. An automated system for business facilitation by an entity on an online social network, the system configured to communicate between a server and at least one remote device via a network, the system comprising:
a data aggregation unit for monitoring and gathering the social network community's activity for each of the plurality of members of an social network community;
an analytics unit which receives input from the data extraction unit and identifies relations between each of the plurality of members' social activity and the social network community; and
a facilitation unit to identify one or more prospects for transmitting at least one offer on behalf of a conduit registered for a campaign for the business facilitation of the entity; wherein the conduit is associated with at least one of the plurality of members using the social network community.

11. The automated system in accordance with claim 10, the system further comprising:
a profile analyzer unit which receives input from the analytics unit for generating a plurality of segments, wherein each segment corresponds to least one of a plurality of members of an social network community; and
an optimization unit for ranking the plurality of members to determine one or more leads based on content preference information.

12. The automated system in accordance with claim 11, wherein the one or more prospects are selected based on the ranking of the plurality of members.

13. The automated system in accordance with claim 11, wherein the optimization unit is configured to compute an interest profile score for each of the plurality of members to determine an affinity towards a marketable commodity selected from a group consisting of goods and services.

14. The automated system in accordance with claim 10, wherein the facilitation engine is configured to compute an influence score of each of the plurality of members to determine one or more prospects.

15. The automated system in accordance with claim 10, wherein the entity comprises at least one of a web entity or a partnership or a disparate group or a business and a group of individuals or an individual or combinations thereof.

16. The automated system in accordance with claim 10, further comprising an incentivizing engine the incentivizing engine configured to:
determine, if an offer transmitted to one or more leads for a consideration has been accepted;
identify, the one or more prospects as leads wherein the offer has been accepted; and
notify, the conduit with an electronic message regarding acceptance of the offer,
wherein the incentivizing engine is configured to receive inputs from the facilitation engine.

17. A computer readable medium having a set of instructions for execution on a computing device, the set of instructions comprising:
data aggregation routine for monitoring and gathering the social network community's activity for each of the plurality of members of an social network community, wherein the social network community is registered for a campaign for business facilitation of the entity;
an analytics routine which receives input from the data extraction unit and identifies relations between each of the plurality of members' social activity and the social network community; and
a facilitation routine to identify one or more prospects for transmitting at least one offer on behalf of a conduit registered for a campaign for the business facilitation of the entity; wherein the conduit is associated with at least one of the plurality of members using the social network community
